(19) United States
(12) Patent Application Publication
(10) Pub. No.: US 2009/0110790 A1
(43) Pub. Date: Apr. 30, 2009

(54) Cake removal plate

(76) Inventor: Kevin Riley, Lancaster, CA (US)

Correspondence Address: ZUBER & TAILLIEU LLP, 10866 WILSHIRE BLVD., SUITE 300, LOS ANGELES, CA, 90024, US

(21) Appl. No.: 11/980,842

(22) Filed: Oct. 30, 2007

(51) Int. Cl. A47J 43/00; A21D 13/08

(52) U.S. Cl. 426/389; 99/644

(57) ABSTRACT

A square shaped cake removal having four outer edges of approximately twelve (12) inches in length and formed of a single piece of material with a uniform thickness throughout of approximately ½ inch to 1 full inch. The material further including a centrally located aperture cut into and through the plate, the centrally located aperture also square in shape and having four inner edges, each of a preferred length of approximately two to two and one-half (2 to 2½) inches on all four sides.

### FIELD OF THE INVENTION

The present invention relates generally to household bakeware. More specifically, the invention pertains to a cake removal device which allows for removal and transfer of a cake in an easy and efficient manner.

### BACKGROUND OF THE INVENTION

The use of cake molds and pans for cooking various types of cakes is well known in the art. Typically, the ingredients for a cake are mixed separately in a bowl and then placed in a mold or pan for baking. The cake mold or pan in then placed in the oven for baking. After it has been fully cooked, the mold or pan is then removed from the oven and allowed to cool. As the cake cools, it often separates from the edges of the mold or pan, after which it may then be completely removed from the baking mold or pan. Sometimes a user may use a knife or spatula to further separate the cake from the pan or mold around the edges.

Typically a user will remove a cake from a pan by simply placing a palm out in a flat fashion and then flipping the pan or mold over onto their palm. The user will then flip the cake back over onto a plate. One benefit of removing a cake in this way is that a user can tell from his or her sense of touch (along with the weight of the cake) when the cake has been fully removed from the pan. Unfortunately, if the cake is too warm and has not cooled sufficiently, this can burn the hand. Additionally, if the pan or mold is too large, the cake may break or fracture during transfer.

Alternatively, a user might use a flat surface, such as a plate or tray and then flip the cake pan or mold over onto the plate or tray. The cake will then be removed from the pan or mold (being placed in an upside down position on the plate). The user might then flip the cake back over, into an upright position, onto another plate. However, this manner of removal is also not always efficient because a user often cannot tell when the cake has been completely removed from the pan or mold. More specifically, unlike the use of a hand, a user cannot feel when the cake has been completely removed and sometimes during removal the user may need to tip the pan or mold slightly to see if the entire cake has been removed, thereby causing the cake to split or break. Additionally, when transferring the cake from the first plate to the second plate, the cake may slide or break.

In short, transfer of a cake to a suitable surface can require several steps and patience. Accordingly, what is needed is an efficient way for removing and transferring a cake from a mold or pan which ensures easy transfer while minimizing the risk of breaking or damaging the cake.

### SUMMARY OF THE INVENTION

The invention includes a square shaped cake removal plate having a centrally located aperture cut into and through the plate. In a preferred embodiment, the plate is formed of a single piece of material having a uniform thickness of approximately one-half (½) inch to one (1) full inch. In a preferred embodiment the outer edges of the square shaped plate are twelve (12) inches in length on all four sides; although it is understood that the size of the plate may vary—dependent upon the size of the cake baking pan or mold. Furthermore, the centrally located aperture is also square in shape and has four inner edges, each of a preferred length of approximately two (2) inches to two and one-half (2½) inches on all four sides (although this again may vary).

The cake removal plate has a top surface where a cake will be placed when using the plate to remove a cake from a baking pan or mold, and this top surface is always preferably flat. The cake removal plate also has a bottom surface. This bottom surface may also be flat or, alternatively, it may be machined or treated in order to have a physically ridged appearance, thereby providing further gripping support to the plate when in use.

In use, the plate is gripped between the thumb and forefinger or index finger, with the thumb grasping an outer edge of the plate and the forefinger or index finger grasping an inner edge of the aperture. The cake plate is then held under a baking pan or mold and a cooled cake is removed from the pan or mold and flipped onto the removal plate.

### DESCRIPTION OF THE DRAWINGS

FIG. 1 is a perspective view of the cake removal plate of the invention;

FIG. 2 is a top down (top surface) view of the cake removal plate of the invention;

FIG. 3 is a side view of the cake removal plate of the invention; and

FIG. 4 illustrates an alternate embodiment for the invention where a bottom surface is ridged for further gripping support.

### DETAILED DESCRIPTION

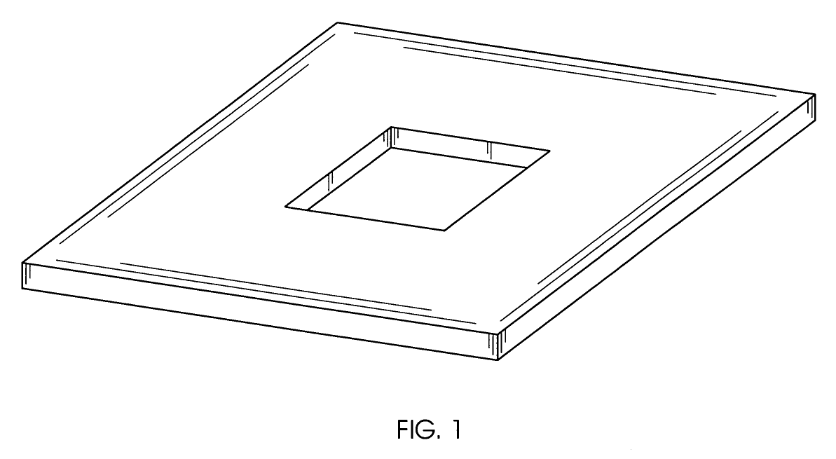

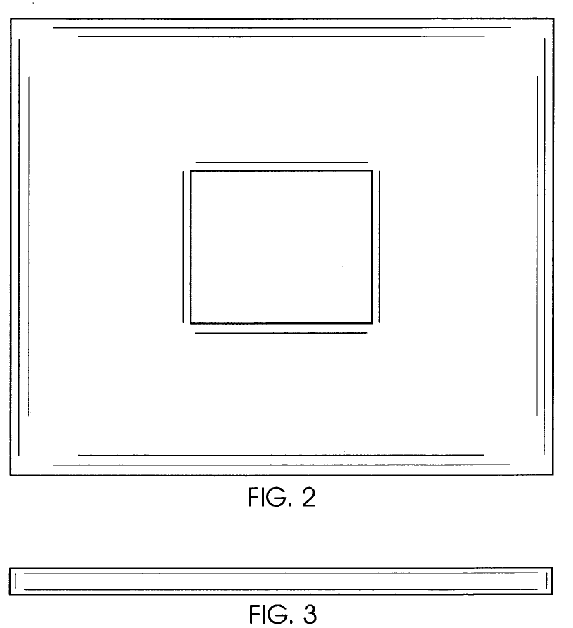

The invention is directed toward a cake removal plate which allows for removal and transfer of a cake from a baking pan or mold in an easy and efficient manner. FIG. 1 illustrates a perspective view of the cake removal plate 10 of the present invention, while FIG. 2 illustrates a top down (i.e. a top side surface) view of the cake removal plate of the present invention. As shown in these figures, the cake removal plate 10 is rectangular, and preferably square in shape. As further shown, the plate 10 has a centrally located aperture 20 cut into and through the plate which allows the plate to be easily gripped, as described in greater detail further hereinafter.

Referring still to FIGS. 1 and 2, the plate preferably has a flat planar upper or top surface and it is understood that the top surface is where a cake will be placed when using the plate to remove a cake from baking pan or mold. Accordingly, this top surface is always preferably flat. Additionally, the plate 10 is formed from one composite piece and may be made from any number of materials including molded plastic or fiberglass, a light weight metal such as tin or aluminum, or even natural or pressed wood.

In a preferred embodiment the outer edges of the square shaped plate are approximately twelve (12) inches in length on all four sides; although it is understood that the size of the plate may vary, dependent upon the size of the cake baking pan or mold, such that the outer edges may be smaller or larger in length. Accordingly, the cake removal plate may be designed in various smaller or larger sizes in keeping with the scope and spirit of the invention.

As further illustrated in FIGS. 1 and 2, the plate includes a centrally located aperture 20 which is also rectangular, and preferably square, in shape. The apertures is positioned centrally within the plate such that respective edge of the four inner edges 30 of the aperture is positioned equidistant from a respective edge of the four outer edges 40 of cake removal plate 10. In a preferred embodiment, the centrally located, square-shaped aperture 20 has a preferred inner edge length of approximately two (2) inches to two and one-half (2½) inches on all four sides (although this again may vary dependent upon the overall size of the cake plate).

FIG. 3 illustrates a side view of the cake removal plate of the present invention. A shown the removal plate 10 is formed of one composite piece having a uniform thickness throughout. In a preferred embodiment, the plate 10 is approximate one-half (½) to one (1) full inch thick such that it may be easily gripped and held, as further described hereinafter. As is further shown, the outer edges 40 are preferably smooth and curved in appearance in order to facilitate comfort and ease in use of the plate, without any danger of cuts or scrapes to the fingers or hand.

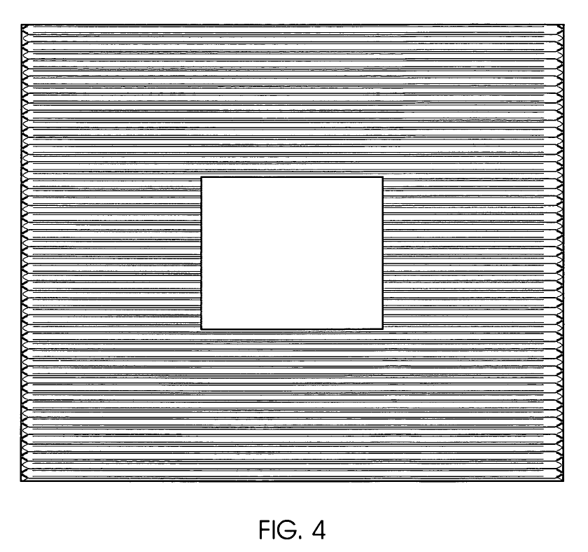

As explained earlier herein, it is understood that the top surface is where a cake will be placed when using the plate to remove a cake from baking pan or mold so this surface is always preferably flat. The bottom surface, however, may vary. Accordingly, the bottom surface may also be flat or, alternatively, it may be machined or treated in order to have a physically ridged appearance, thereby providing further gripping support to the plate when in use. FIG. 4, illustrates such an alternative bottom surface of the cake removal plate of the present invention having a ridged surface.

In use, the cake removal plate of the invention is gripped between the thumb and forefinger (middle finger) or index finger, such that the thumb grasps an outer edge 40 of the plate and the forefinger (middle finger) or index finger grasps an inner edge 30 of the aperture, with the plate being held therebetween. In use, the plate 10 may be further supported by using the other fingers of the hand to provide support to the bottom surface of the plate. Once the plate has been firmly grasped, a baking pan or mold is then placed over the plate in an inverted fashion, such that a cooled cake is removed from the pan or mold and flipped onto the removal plate of the invention.

Although a preferred embodiment of the present invention has been described for illustrative purposes, those skilled in the art will appreciate that various modifications, additions and substitutions are possible, without departing from the spirit and scope of the invention and the invention is not intended to be limited to any one particular embodiment except as described and limited in the claims set forth hereinafter.

I claim:

1. A cake removal plate comprising:
a uniformly thick piece material having a substantially flat upper or top surface and a bottom surface, said material being square in shape and having four outer edges; and
a square shaped aperture centrally located within said material and having four inner edges.

2. The cake removal plate of claim 1, wherein the material is plastic.

3. The cake removal plate of claim 1, wherein the bottom surface is ridged.

4. The cake removal plate of claim 1, wherein the material is preferably one-half (½) inch to one (1) full inch in thickness.

5. The cake removal plate of claim 1, wherein the each of the four outer edges is approximately twelve (12) inches in length.

6. The cake removal plate of claim 5, wherein the each of the four inner edges is between two (2) and two and one-half (2½) inches in length.

7. A cake removal plate comprising:
a uniformly thick piece of plastic material having a substantially flat upper or top surface and a ridged bottom surface, said material being square in shape and having four outer edges; and
a square shaped aperture centrally located within said material and having four inner edges.

8. The cake removal plate of claim 7, wherein the material is preferably one-half (½) inch to one (1) full inch in thickness.

9. The cake removal plate of claim 7, wherein the each of the four outer edges is approximately twelve (12) inches in length.

10. The cake removal plate of claim 9, wherein the each of the four inner edges is between two (2) and two and one-half (2½) inches in length.

11. A method for removing a cake from a baking pan or mold comprising:
utilizing a uniformly thick piece of material having a substantially flat upper or top surface, said material being square in shape and having four outer edges, said material further including a square shaped aperture centrally located within and through said material, thereby forming four inner edges;
placing the cake pan or mold over the top surface of said uniformly thick piece of material between;
allowing the cake to displace itself from the pan or mold onto the top surface of said uniformly thick piece of material.

12. The method of claim 11, wherein the material is preferably one-half (½) inch to one (1) full inch in thickness.

13. The method of claim 11, wherein the each of the four outer edges is approximately twelve (12) inches in length.

14. The method of claim 13, wherein the each of the four inner edges is between two (2) and two and one-half (2½) inches in length.
